(19) United States
(12) Patent Application Publication
(10) Pub. No.: US 2012/0251790 A1
(43) Pub. Date: Oct. 4, 2012

(54) SYSTEMS AND METHODS FOR CREATING SHARP FEATURES WITHIN A MOLD

(75) Inventors: Robert P. Harhen, Haverhill, MA (US); Rafael M. Cordero, Bedford, MA (US); Adam J. Young, Dedham, MA (US); Marc Davidson, Andover, MA (US)

(73) Assignee: Nellcor Puritan Bennett LLC, Boulder, CO (US)

(21) Appl. No.: 13/077,148

(22) Filed: Mar. 31, 2011

(51) Int. Cl. B32B 3/26; B29C 45/40; B29C 33/42

(52) U.S. Cl. 428/172; 425/330; 264/328.1

(57) ABSTRACT

The present disclosure describes systems and methods for creating sharp features within a mold. For example, three or more mold plates may be provided to create a single mold assembly. Each mold plate includes one or more mold cavities, each having one or more surfaces. The provided mold plates may be assembled to form the mold assembly having a combined mold cavity between adjacent mold cavities of the mold plates. Although none of the individual mold cavities of the mold plates include sharp features, when the mold assembly is assembled, a combined mold cavity will include sharp transitions (e.g., angles of less than 180 degrees, right angles, angles of less than 90 degrees, and so forth) between adjacent surfaces of the mold cavities. In certain embodiments, sets of mold plates may be re-aligned to create varying mold cavity geometries. In addition, in certain embodiments, a mold pin may be inserted into an inner volume of a mold plate to both create additional sharp transitions between adjacent surfaces.

### BACKGROUND

The present disclosure relates generally to molding techniques and, more particularly, to systems and methods for creating sharp features within a mold.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In conventional practice, medical application devices are often created by molding thermoplastic materials into particular shapes using molds that form the desired shapes. More specifically, a thermoplastic material is introduced into a mold using one of many various molding techniques. The thermoplastic material takes the shape of a mold cavity of the mold, into which the thermoplastic material is introduced. However, the mold cavities are often created in the molds using techniques (e.g., electrical discharge machining (EDM)) that do not facilitate the creation of sharp features (e.g., transitions between surfaces) within the mold cavities. More specifically, instead of being able to create sharp features in the mold cavities, the conventional techniques often merely approximate sharp features while still creating relatively small radius fillets in the mold cavities. In other words, conventional mold cavities typically include only linear or curvilinear surfaces and linear or curvilinear transitions between adjacent surfaces. As such, there is a need for improved techniques for creating sharp features within mold cavities.

### BRIEF DESCRIPTION OF THE DRAWINGS

Advantages of this disclosure may become apparent upon reading the following detailed description and upon reference to the drawings in which:

FIGS. 1A and 1B depict first and second mold plates having respective first and second surfaces that abut at transition points when the first and second mold plates are aligned with each other;

FIG. 2 is a perspective view of a mold assembly having first, second, and third mold plates in accordance with an embodiment;

FIG. 3 is a perspective view of a mold assembly having first and second mold plates in accordance with an embodiment;

FIGS. 4A and 4B illustrate side views of a molded component created using the mold assembly of FIG. 3;

FIG. 5 is a perspective view of a mold assembly having first and second mold plates in accordance with an embodiment;

FIG. 6 is a perspective view of a mold assembly that utilizes the first and second mold plates of FIG. 5 in accordance with an embodiment;

FIG. 7 is a perspective view of a mold assembly having first and second mold plates in accordance with an embodiment;

FIG. 8 is a transparent perspective view of an unassembled mold assembly having complex mold cavity geometries in accordance with an embodiment

FIG. 9 is a transparent perspective view of the mold assembly of FIG. 8 assembled together in accordance with an embodiment;

FIG. 10 is a perspective view of a molded piece left in place around a mold pin of the mold assembly of FIGS. 8 and 9 in accordance with an embodiment;

FIG. 11 is a perspective view of the molded piece of FIG. 10 once it has been removed from around the mold pin in accordance with an embodiment;

FIGS. 12A and 12B are perspective views of an electroencephalography (EEG) sensor and associated molded piece in accordance with an embodiment;

FIG. 13 is a perspective view of a mold plate having multiple mold plate pieces in accordance with an embodiment; and

FIG. 14 is a side view of first and second mold plates that meet at a point and include an acute sharp feature between abutting sides of the respective mold plates in accordance with an embodiment.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As discussed in detail below, various embodiments are provided of a mold assembly of three or more mold plates (i.e., tooling plates of the mold assembly), each mold plate having one or more mold cavities. When the mold plates of the mold assembly are aligned with each other, the mold cavities of the mold plates form a combined mold cavity having one or more sharp transitions that are formed between surfaces of the mold cavities of the mold plates. More specifically, as described in greater detail below, the sharp transitions formed between surfaces of the mold cavities of the mold plates are not smooth transitions, such as curved or filleted transitions. Rather, in certain embodiments, the sharp transitions may be described as including right angles, obtuse angles (e.g., between 90 degrees and 180 degrees), and/or acute angles (e.g., less than 90 degrees) between abutting surfaces of the mold cavities of the mold plates. In other words, the sharp transitions between abutting surfaces of the mold cavities of the mold plates are not linear or curvilinear. The sharp transitions between abutting surfaces of the mold cavities of the mold plates are formed by intersections that may be machined flat, rather than machined as an edge of a block mold.

In other words, the devices and techniques provided herein enable the creation of molded products defined by relatively sharp edges. As such, problems associated with limitations of conventional molding techniques are minimized. More specifically, as described above, conventional molds are typically created using techniques (e.g., electrical discharge machining (EDM)) that often only facilitate the creation of relatively rounded transitions, due to inherent limitations of these techniques. For example, EDM techniques typically include electrically burning mold cavities into a steel mold using carbon electrodes operating at high voltages. This method of machining mold cavities relies on a machined carbon electrode containing the feature that is to be “burned” into the steel mold. While the carbon electrode may contain transitional features of +/−0.002 inches, this tolerance does not meet the requirements for creating very sharp features desirable in certain applications. In addition, wire EDM techniques use a very fine wire to slowly cut through the steel mold using electrical discharge. This method is also somewhat precise, but still falls short of producing sharp enough transitions as may be desirable in certain applications, such as transdermal drug delivery systems (e.g., microneedles, and so forth). Furthermore, other traditional milling techniques (e.g., square mill techniques) also have proven insufficient to create very sharp transitions between surfaces of mold cavities.

The devices and techniques provided herein overcome these limitations by facilitating the creation of sharp transitions between surfaces of abutting mold cavities of adjacent mold plates of a mold assembly. In addition, the devices and techniques provided herein are relatively modular in nature, enhancing the reusability and adaptability of the mold assemblies. For example, as described in greater detail below, in certain embodiments, the modular mold plates may be re-aligned into various configurations to create varying mold cavity geometries with varying sharp features. It should be noted that while the mold cavities of the mold plates may individually be machined using conventional techniques (e.g., EDM techniques), when the mold plates are assembled together, the resulting mold assembly includes a combined mold cavity that contains sharp features that would otherwise have been very difficult, if not impossible, to create using the conventional machining techniques. In addition, as described in greater detail below, once the modular mold plates are assembled together to form the mold assemblies, two or more of the mold plates remain assembled together during multiple cycles of the molding operation. In other words, multiple molded pieces (i.e., formed during multiple respective cycles) may be formed using the mold assemblies while the two or more mold plates remain assembled together.

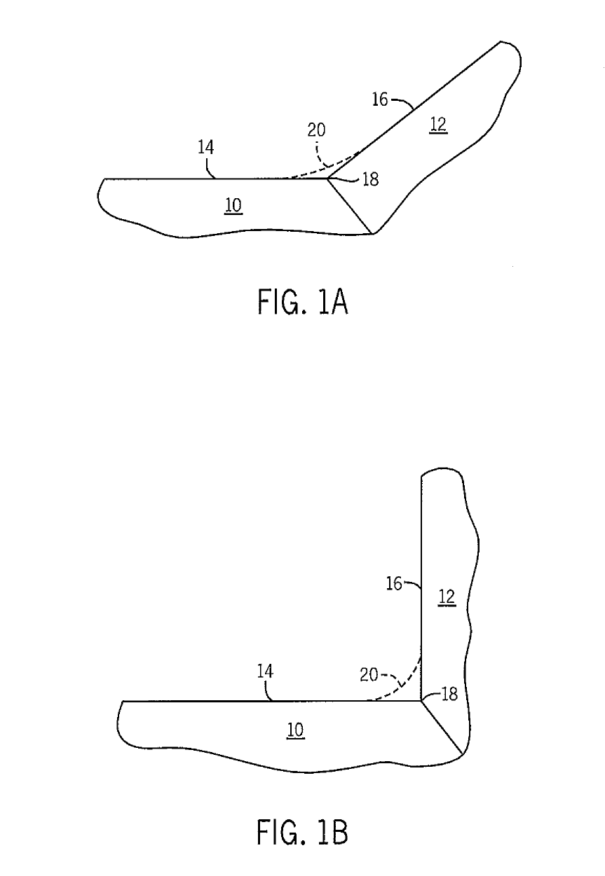

Turning now to the drawings, FIG. 1A depicts a first and second mold plate 10, 12 having respective first and second surfaces 14, 16 that abut at a point 18 when the first and second mold plates 10, 12 are aligned with each other. As illustrated in FIG. 1A, the first surface 14 of the first mold plate 10 and the second surface 16 of the second mold plate 12 abut at the point 18, such that a sharp transition in the form of an obtuse angle (e.g., between 90 degrees and 180 degrees) is created between the first and second surfaces 14, 16. To illustrate the advantages of the techniques described herein, dashed line 20 illustrates a single mold cavity surface that would be created using conventional techniques (e.g., EDM) to create the mold cavity. As illustrated, the conventional mold cavity surface 20 does not include a sharp transition, but rather a relatively smooth curve.

Similarly, FIG. 1B depicts another first and second mold plate 10, 12 having respective first and second surfaces 14, 16 that abut at the point 18 when the first and second mold plates 10, 12 are aligned with each other. As illustrated in FIG. 1B, the first surface 14 of the first mold plate 10 and the second surface 16 of the second mold plate 12 abut at the point 18, such that a sharp transition in the form of a right angle (e.g., equal to 90 degrees) is created between the first and second surfaces 14, 16. Again, to illustrate the advantages of the techniques described herein, dashed line 20 illustrates a mold cavity surface that would be created using conventional techniques (e.g., EDM) to create the mold cavity. In addition, in certain embodiments, acute angles (e.g., less than 90 degrees) may also be created between the first and second surfaces 14, 16. FIGS. 1A and 1B are merely examples of the types of sharp features that may be created between first and second surfaces 14, 16 of aligned first and second mold plates 10, 12. The following figures and related description provide specific embodiments that lead to the types of sharp features illustrated in FIGS. 1A and 1B.

For example, FIG. 2 is a perspective view of a mold assembly 22 having first, second, and third mold plates 24, 26, 28 in accordance with an embodiment. The first, second, and third mold plates 24, 26, 28 of FIG. 2 function in a similar manner to the first and second mold plates 10, 12 of FIGS. 1A and 1B. However, FIG. 2 is more illustrative of the more complex mold cavities that may be created. More specifically, as illustrated in FIG. 2, each mold plate 24, 26, 28 includes a generally semi-circular shaped body 30. More specifically, the three mold plates 24, 26, 28 depicted in FIG. 2 are substantially similar in shape, such that they align together to form a generally circular mold assembly 22. However, as illustrated in further embodiments, the various mold plates of any given mold assembly are not necessarily similarly sized and shaped. Indeed, as described in greater detail below, using mold plates having various sizes, shapes, and mold cavity dimensions enables the creation of various combined mold cavities.

As illustrated in FIG. 2, each mold plate 24, 26, 28 includes a surface 32 that may be used to form a mold cavity when the mold plates 24, 26, 28 are aligned with each other. In particular, in the embodiment illustrated in FIG. 2, each mold plate 24, 26, 28 includes a generally triangular shaped surface 32 with sides of the triangular shape being defined by an upper side 34 and two interior sides 36, 38 of the respective mold plates 24, 26, 28. As illustrated in FIG. 2, when the mold plates 24, 26, 28 are aligned with each other as illustrated by arrows 40, the surfaces 32 of the mold plates 24, 26, 28 abut to form a mold cavity 42 being shaped as a triangular pyramid. As such, the lines 44 of the surfaces 32 of the mold plates 24, 26, 28 that abut each other form sharp transitions between each other. More specifically, each of the lines 44 form acute angles between the abutting surfaces 32.

The mold assembly 22 of FIG. 2 also includes an additional mold plate 45 that is assembled with (i.e., attached to) the three mold plates 24, 26, 28 to close the mold cavity 42 formed between the three mold plates 24, 26, 28 before injection of a thermoplastic material into the mold cavity 42, and is separated (i.e., detached) from the three mold plates 24, 26, 28 to facilitate removal of the resulting molded piece from the mold cavity 42 once the thermoplastic material has set. However, the three mold plates 24, 26, 28 remain assembled together during multiple cycles of the molding operation (i.e., during creation of multiple molded pieces by injection of the thermoplastic material into the mold cavity 42 and subsequent removal of the resulting molded piece).

In the embodiment illustrated in FIG. 2, as well as all of the embodiments presented herein, the mold plates 24, 26, 28 may be precut with the surfaces 32 machined thereon, and the mold plates 24, 26, 28 may be mounted in the form of a drill chuck. As described above, when the surfaces 32 are aligned together, they form the basis of a new geometry (i.e., the combined mold cavity 42). When a thermoplastic material is inserted into the resulting mold cavity 42, the area where the mated surfaces 32 meet create the sharp edged geometries on the resulting molded piece. In addition, the area where the surfaces 32 meet creates a controlled venting edge that helps push the thermoplastic material toward a complete fill of the very sharp features.

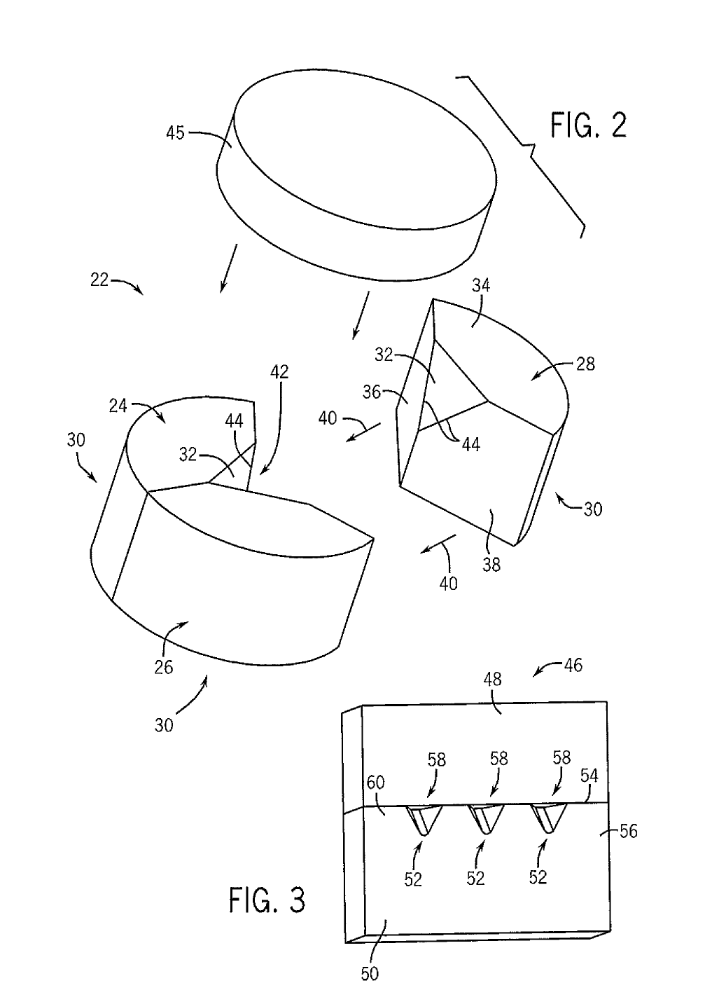

FIG. 3 is a perspective view of another mold assembly 46 having first and second mold plates 48, 50 in accordance with an embodiment. In particular, the embodiment illustrated in FIG. 3 has a first mold plate 48 that does not have any mold cavities machined thereon. Rather, the first mold plate 48 is simply a rectangular shaped mold plate. However, the second mold plate 50 includes a plurality of mold cavities 52 machined thereon. More specifically, the mold cavities 52 of the second mold plate 50 are illustrated as generally triangular shaped mold cavities 52 machined into one side 54 of a top face 56 of the second mold plate 50. Although the mold cavities 52 of the second mold plate 50 do not themselves include any sharp features, when the first and second mold plates 48, 50 are aligned together, the resulting combined mold cavities (i.e., the combined volumes between the first and second mold plates 48, 50) includes several sharp features. Indeed, in the embodiment illustrated in FIG. 3, all points at which the side 60 of the first mold plate 48 abut the generally triangular shaped mold cavities 52 will form sharp transitions.

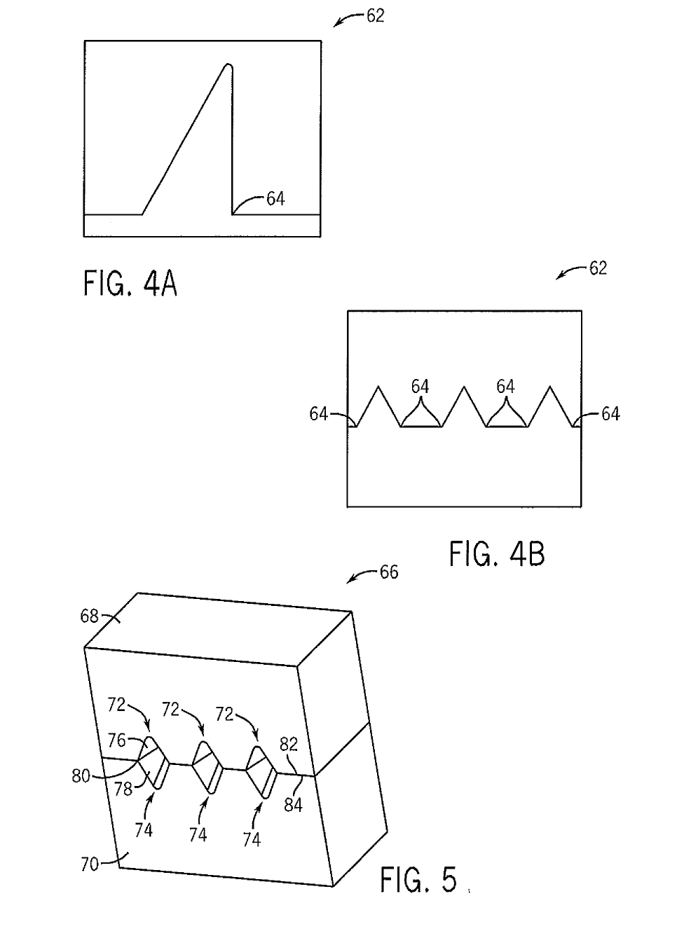

For example, FIGS. 4A and 4B illustrate side views of a molded piece 62 created using the mold assembly 46 illustrated in FIG. 3. As illustrated in FIGS. 4A and 4B, the resulting molded piece 62 may, for example, include sharp edges 64 that are formed at the points at which the first and second mold plates 48, 50 of FIG. 3 abut. More specifically, the molded piece 62 of FIGS. 4A and 4B includes a half pyramid with a very sharp edge along the parting line (e.g., where sides 60, 54 of the respective first and second mold plates 48, 50 abut).

Again, the mold assembly 46 of FIG. 3 also includes an additional mold plate (not shown), similar to mold plate 45 of FIG. 2, that is assembled with (i.e., attached to) the first and second mold plates 48, 50 to close the mold cavities 52 formed between the first and second mold plates 48, 50 before injection of a thermoplastic material into the mold cavities 52, and is separated (i.e., detached) from the first and second mold plates 48, 50 to facilitate removal of the resulting molded pieces from the mold cavities 52 once the thermoplastic material has set. However, the first and second mold plates 48, 50 remain assembled together during multiple cycles of the molding operation (i.e., during creation of multiple sets of molded pieces by injection of the thermoplastic material into the mold cavities 52 and subsequent removal of the resulting sets of molded pieces).

In certain embodiments, the first and second mold plates 48, 50 illustrated in FIG. 3, as well as all of the embodiments presented herein, may be used in a modular fashion to create various mold cavities. For example, FIG. 5 is a perspective view of a mold assembly 66 having first and second mold plates 68, 70 in accordance with an embodiment. In the embodiment illustrated in FIG. 5, the first and second mold plates 68, 70 of the mold assembly 66 are substantially similar to the second mold plate 50 of the mold assembly 46 of FIG. 3. However, in other embodiments, the first and second mold plates 68, 70 of the mold assembly 66 of FIG. 5 (as well as any other mold assembly embodiments) may include different mold plate designs that incorporate different mold cavities.

In the embodiment illustrated in FIG. 5, the first and second mold plates 68, 70 each have a plurality of respective mold cavities 72, 74 similar to the generally triangular shaped mold cavities 52 of the second mold plate 50 of the mold assembly 46 of FIG. 3. Again, the mold cavities 72, 74 of the first and second mold plates 68, 70 do not themselves include any sharp features. In other words, the mold cavities 72, 74 include generally smooth interior surfaces 76, 78 that may have been created using conventional machining techniques such as EDM. However, when the first and second mold plates 68, 70 are aligned together, the respective interior surfaces 76, 78 form sharp transitions at points 80 where the interior surfaces 76, 78 meet. It should be noted that the points 80 where the interior surfaces 76, 78 meet to form sharp transitions are not only along outer faces of the mold plates 68, 70, but also at inner locations within the mold cavities 72, 74.

Again, the mold assembly 66 of FIG. 5 also includes an additional mold plate (not shown), similar to mold plate 45 of FIG. 2, that is assembled with (i.e., attached to) the first and second mold plates 68, 70 to close the mold cavities 72, 74 formed between the first and second mold plates 68, 70 before injection of a thermoplastic material into the mold cavities 72, 74, and is separated (i.e., detached) from the first and second mold plates 68, 70 to facilitate removal of the resulting molded pieces from the mold cavities 72, 74 once the thermoplastic material has set. However, the first and second mold plates 68, 70 remain assembled together during multiple cycles of the molding operation (i.e., during creation of multiple sets of molded pieces by injection of the thermoplastic material into the mold cavities 72, 74 and subsequent removal of the resulting sets of molded pieces).

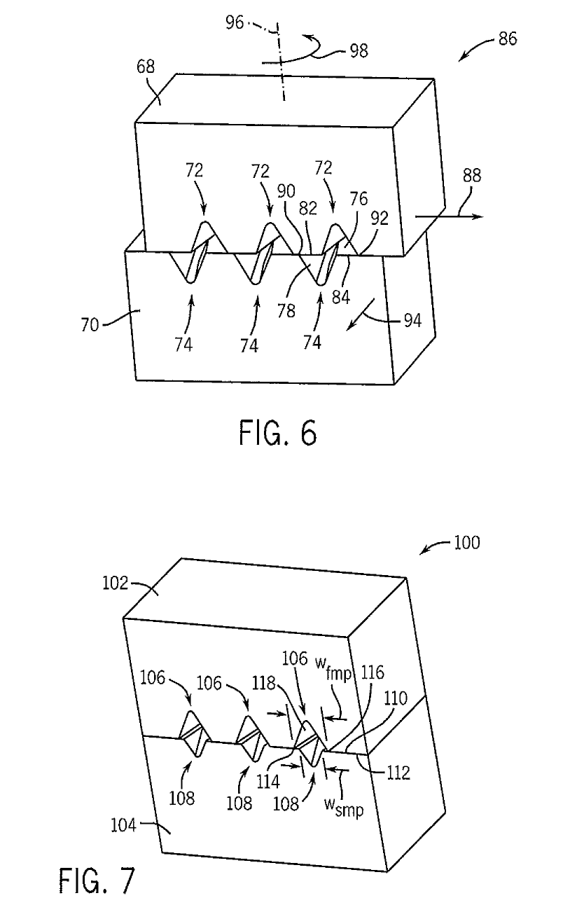

In the embodiment illustrated in FIG. 5, the mold cavities 72, 74 of the first and second mold plates 68, 70 generally align such that only the interior surfaces 76, 78 of the mold cavities 72, 74 abut. However, as will be illustrated in further embodiments, the first and second mold plates 68, 70 may be aligned such that respective side walls 82, 84 of the first and second mold plates 68, 70 also form sharp transitions with the interior surfaces 76, 78 of the mold cavities 72, 74. For example, FIG. 6 is a perspective view of a mold assembly 86 that utilizes the first and second mold plates 68, 70 of FIG. 5 in accordance with an embodiment. However, in the embodiment illustrated in FIG. 6, the first mold plate 68 has been offset with respect to the second mold plate 70, as illustrated by arrow 88. As such, in addition to the sharp transitions that are formed at points where the interior surfaces 76, 78 of the mold cavities 72, 74 abut, the interior surfaces 76, 78 of the mold cavities 72, 74 also form sharp transitions at points where the interior surfaces 76, 78 abut the side walls 82, 84 of the opposite mold plate 68, 70.

For example, as illustrated in FIG. 6, the interior surfaces 78 of the mold cavities 74 of the second mold plate 70 form sharp transitions at points 90 where the side wall 82 of the first mold plate 68 abut the interior surfaces 78 of the mold cavities 74 of the second mold plate 70. Similarly, the interior surfaces 76 of the mold cavities 72 of the first mold plate 68 form sharp transitions at points 92 where the side wall 84 of the second mold plate 70 abut the interior surfaces 76 of the mold cavities 72 of the first mold plate 68. Again, it should be noted that the points 90, 92 where the interior surfaces 76, 78 abut the side walls 82, 84 to form sharp transitions are not only along outer faces of the mold plates 68, 70, but also at inner locations within the mold cavities 72, 74.

As such, the mold assembly 86 of FIG. 6 illustrates how the mold plates described herein (e.g., the first and second mold plates 68, 70 of FIGS. 5 and 6) may be used in a modular manner to create various combined mold cavities (e.g., the mold cavities 72, 74 combined together) based on various orientations of the mold plates 68, 70. Indeed, although illustrated in FIG. 6 as being re-aligned only in one direction (e.g., along arrow 88), in certain embodiments, the modular mold plates 68, 70 may be re-aligned in other directions (e.g., as illustrated by arrow 94) with respect to each other, as well as being rotated with respect to each other about an axis 96 (e.g., as illustrated by arrow 98).

Again, the mold assembly 86 of FIG. 6 also includes an additional mold plate (not shown), similar to mold plate 45 of FIG. 2, that is assembled with (i.e., attached to) the first and second mold plates 68, 70 to close the mold cavities 72, 74 formed between the first and second mold plates 68, 70 before injection of a thermoplastic material into the mold cavities 72, 74, and is separated (i.e., detached) from the first and second mold plates 68, 70 to facilitate removal of the resulting molded pieces from the mold cavities 72, 74 once the thermoplastic material has set. However, the first and second mold plates 68, 70 remain assembled together during multiple cycles of the molding operation (i.e., during creation of multiple sets of molded pieces by injection of the thermoplastic material into the mold cavities 72, 74 and subsequent removal of the resulting sets of molded pieces).

In addition, although illustrated in FIGS. 5 and 6 as including substantially similarly shaped mold cavities 72, 74, in other embodiments, the mold plates used to form the mold assemblies may include mold cavities that are shaped differently and/or sized differently. For example, FIG. 7 is a perspective view of a mold assembly 100 having first and second mold plates 102, 104 in accordance with an embodiment. In the embodiment illustrated in FIG. 7, both the first and second mold plates 102, 104 again include a plurality of generally triangular shaped mold cavities 106, 108. However, as opposed to be substantially similarly shaped and sized, in the embodiment illustrated in FIG. 7, the mold cavities 106 of the first mold plate 102 are slightly larger than the mold cavities 108 of the second mold plate 104. More specifically, the mold cavities 106 of the first mold plate 102 have a slightly larger width w_{fmp} than the width wₛₘₚ of the mold cavities 108 of the second mold plate 104 along respective side walls 110, 112 of the first and second mold plates 102, 104. As such, sharp transitions are formed at points 114, 116 on either side of the mold cavities 106 of the first mold plate 102 where interior surfaces 118 of the mold cavities 106 abut the side wall 112 of the second mold plate 104. Again, it should be noted that the points 114, 116 where the interior surfaces 118 abut the side wall 112 to form sharp transitions are not only along outer faces of the mold plates 102, 104, but also at inner locations within the mold cavities 106, 108.

Again, the mold assembly 100 of FIG. 7 also includes an additional mold plate (not shown), similar to mold plate 45 of FIG. 2, that is assembled with (i.e., attached to) the first and second mold plates 102, 104 to close the mold cavities 106, 108 formed between the first and second mold plates 102, 104 before injection of a thermoplastic material into the mold cavities 106, 108, and is separated (i.e., detached) from the first and second mold plates 102, 104 to facilitate removal of the resulting molded pieces from the mold cavities 106, 108 once the thermoplastic material has set. However, the first and second mold plates 102, 104 remain assembled together during multiple cycles of the molding operation (i.e., during creation of multiple sets of molded pieces by injection of the thermoplastic material into the mold cavities 106, 108 and subsequent removal of the resulting sets of molded pieces).

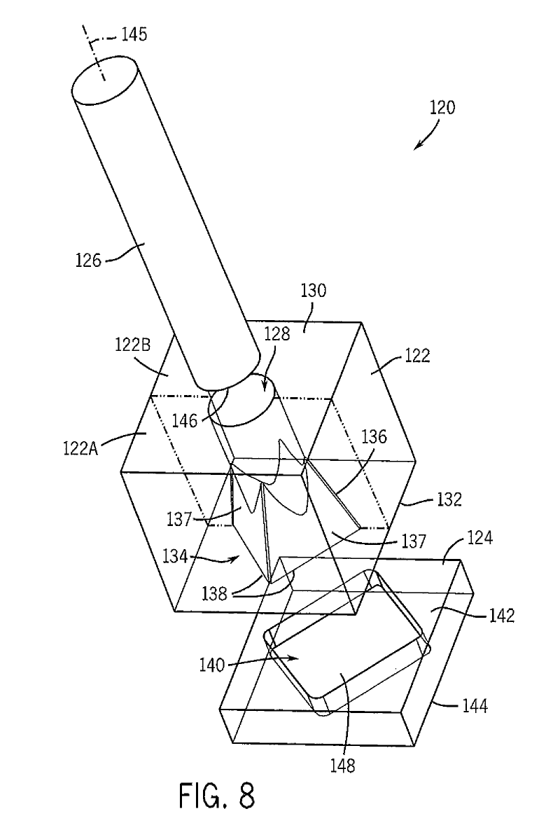

As described above, the embodiments illustrated in FIGS. 5 through 7 include mold plates having generally triangular shaped mold cavities. However, the mold cavities used in the mold plates may include more complex geometries that may be used to create molded parts with more complex sharp features. For example, FIG. 8 is a transparent perspective view of an unassembled mold assembly 120 having more complex mold cavity geometries in accordance with an embodiment. As illustrated, the mold assembly 120 includes first mold plates 122, 124, and a mold pin 126. More specifically, the generally rectangular shaped first mold plate 122 includes a generally cylindrical inner volume 128 extending from a first side 130 toward an opposite second side 132 of the first mold plate 122. However, instead of extending all the way from the first side 130 to the second side of the first mold plate 122, the cylindrical inner volume 128 is adjacent a hollowed out inner volume 134 that extends from the second side 132 toward the first side 130 of the first mold plate 122. More specifically, the hollowed out inner volume 134 extends from a generally rectangular base 136 at the second side 132 of the first mold plate 122 with inner walls 137 having tapered angles leading into the cylindrical inner volume 128. In certain embodiments, the length of the sides 138 of the rectangular base 136 may be greater than the diameter of the cylindrical inner volume 128. However, in other embodiments, the length of the sides 138 of the rectangular base 136 may not be greater than the diameter of the cylindrical inner volume 128. More specifically, as long as the diagonal length between opposing corners of the rectangular base 136 is larger than the diameter of the cylindrical inner volume 128, then the sharp features may be achieved.

The mold assembly 120 of FIG. 8 also includes the generally rectangular shaped second mold plate 124, which includes a generally rectangular cutout section 140 on a first side 142 of the second mold plate 124. The rectangular cutout section 140 generally aligns with the rectangular base 136 of the first mold plate 122 when the mold assembly 120 is assembled, and does not extend all the way through to a second side 144 of the second mold plate 124 that is opposite the first side 142.

Once the first and second mold plates 122, 124 are aligned with each other (i.e., the second side 132 of the first mold plate 122 is positioned adjacent the first side 142 of the second mold plate 124), the mold pin 126 may be inserted through the cylindrical inner volume 128 along an axis 145 of the cylindrical inner volume 128, the hollowed out volume 134, and the rectangular cutout section 140 such that an end 146 of the mold pin 126 abuts a generally planar interior surface 148 of the rectangular cutout section 140. It should be noted that the inner volume 128 is concentric to the axis 145, which is orthogonal to the rectangular base 136 of the first mold plate 122 and the interior surface 148 of the rectangular cutout section 140.

Although illustrated as being a cylindrical mold pin 126 that fits within the cylindrical inner volume 128 of the first mold plate 122, in other embodiments, the mold pin 126 may be of different cross-sectional shapes (e.g., rectangular) that fit within the similarly shaped inner volume 128. The mold pin 126 creates an interruption in the original geometry between the first and second mold plates 122, 124, forcing a new geometry that contains sharp edges at various points. As described in greater detail below, the resulting molded piece contains very sharp tines upon removal of the mold pin 126.

Once the first mold plate 122, the second mold plate 124, and the mold pin 126 are assembled into the mold assembly 120, the first mold plate 122, the second mold plate 124, and the mold pin 126 may be attached to each other using any suitable attachment features (e.g., locks, latches, screws, bolts, or other fasteners). In certain embodiments, the first mold plate 122 may include two or more mold pieces 122A, 122B (i.e., two mold pieces 122A, 122B separated by the dashed line in FIG. 8) that may be attached to each other when the mold assembly 120 is assembled. As described in greater detail below, including multiple mold pieces 122A, 122B in the first mold plate 122 may enhance the sharp features created in the mold assembly 120.

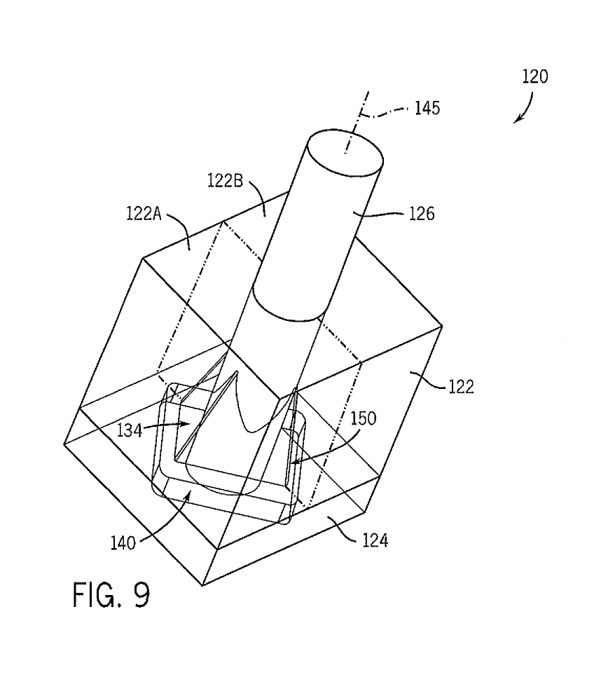

FIG. 9 is a transparent perspective view of the mold assembly 120 of FIG. 8 assembled together in accordance with an embodiment, As illustrated, an interior space 150 (i.e., an interior mold cavity) is formed between the mold pin 126, the hollowed out volume 134 of the first mold plate 122, and the rectangular cutout section 140 of the second mold plate 124. The thermoplastic material may be injected into the interior space 150 to create a molded piece.

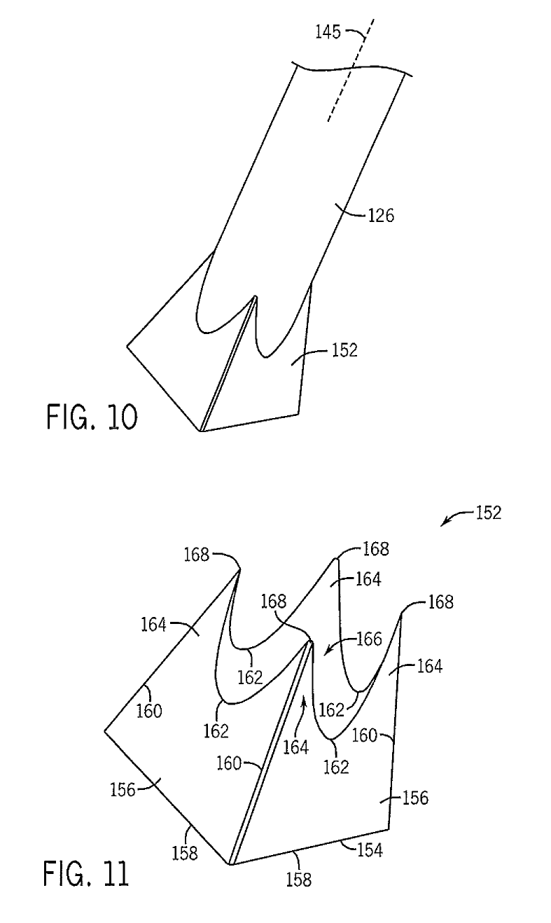

Once the thermoplastic material has been set into the molded piece, the first and second mold plates 122, 124 of the mold assembly 120 of FIGS. 8 and 9 may first be removed from around the molded piece, while leaving the mold pin 126 in place. FIG. 10 is a perspective view of a molded piece 152 left in place around the mold pin 126 in accordance with an embodiment. In certain embodiments, the mold pin 126 may also be removed from within the molded piece 152. FIG. 11 is a perspective view of the molded piece 152 of FIG. 10 once it has been removed from around the mold pin 126 in accordance with an embodiment. As illustrated in FIG. 11, the one-piece molded piece 152 created by the mold assembly 120 of FIGS. 8 and 9 may include several sharp features that would otherwise not have been possible using conventional mold machining techniques.

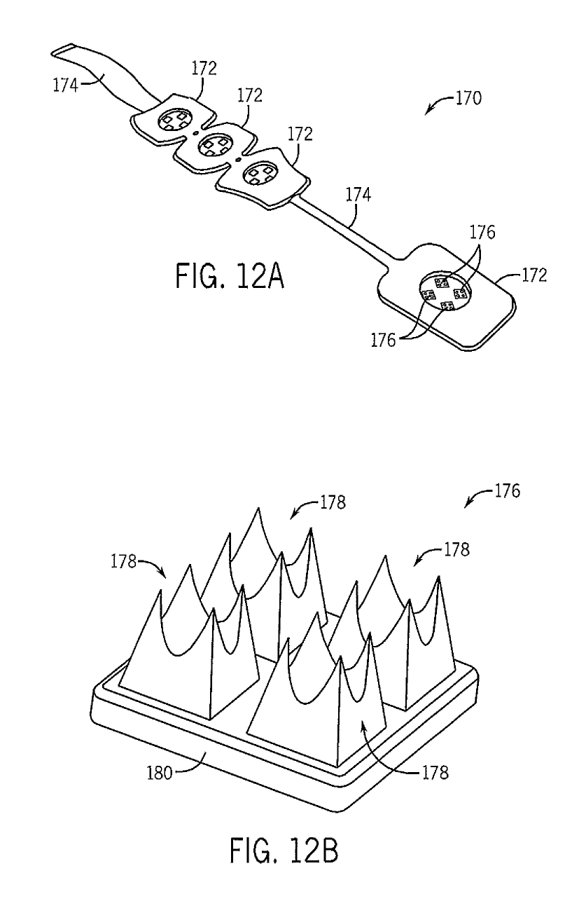

For example, the molded piece 152 includes a rectangular base 154 with four angled side walls 156 extending from the four edges 158 of the rectangular base 154. More specifically, as described above, the four angled side walls 156 of the molded piece 152 are angled inwardly from their respective edge 158 of the rectangular base 154 to where an outer diameter of the mold pin 126 was located during the molding process. As such, the edges 158 where the angled side walls 156 abut the rectangular base 154 form sharp features (e.g., in this instance, acute angled features). However, in certain embodiments, as described below with respect to FIGS. 12A and 12B, these particular sharp features may be attached to a medical device component (e.g., medical device sensors, and so forth) at the rectangular base 154, such that the acute angled features may not actually be present in the resulting medical device component. Similarly, edges 160 between abutting angled side walls 156 also form sharp features (e.g., also in this instance, acute angled features).

In addition, each of the angled side walls 156 of the molded piece 152 include a parabolic shaped edge 162 opposite its respective edge 158 where the angled side wall 156 abuts the rectangular base 154. The parabolic shape of the edge 162 is created due to the positioning of the mold pin 126 with respect to the first mold plate 122 of the mold assembly 120 of FIGS. 8 and 9, which allows the thermoplastic material to enter the interior space 150 within the mold assembly 120 such that four tines 164 extend from the molded piece 152, as illustrated in FIGS. 10 and 11. More specifically, each of the tines 164 is formed between the generally cylindrical inner volume 166 of the molded piece 152 and abutting angled side walls 156. Each tine 164 extends to a point 168 along the edge 160 between abutting angled side walls 156. The point 168 of each tine 164 is also where adjacent parabolic shaped edges 162 abut. Again, the sharp features of the tines 164 of the molded piece 152 are created using the techniques described herein of combining two or more mold plates having relatively smooth mold cavity features to create a mold assembly having a combined mold cavity with relatively sharp features.

The particular design of the molded piece 152 of FIGS. 10 and 11 may be particularly beneficial for certain applications. For example, in the field of electroencephalography (EEG), the molded piece 152 may be used in EEG sensors. For example, FIG. 12A is a perspective view of an example of an EEG sensor 170 that utilizes molded pieces similar to those depicted in FIGS. 10 and 11. As illustrated in FIG. 12A, the EEG sensor 170 includes a plurality of electrodes 172 configured to attach to the skin of a patient to detect electrical activity within the patient's brain, and transmit data relating to the electrical activity to an EEG monitoring system via cables (e.g., ribbon cables) that are connected to the electrodes 172. As also illustrated in FIG. 12A, each electrode 172 may include one or more (e.g., four in the illustrated embodiment) molded pieces 176, which are molded using the techniques presented herein.

FIG. 12B is a perspective view of an example of the molded piece 176 of the EEG sensor 170 of FIG. 12A in accordance with an embodiment. As illustrated, the molded piece 176 includes a plurality of molded sections 178 similar to the molded pieces 152 depicted in the embodiments of FIGS. 10 and 11. However, the molded piece 176 depicted in FIG. 12B includes a generally rectangular base 180 to which the molded sections 178 are attached. It will be appreciated that the molded sections 178 of the molded piece 176 are created using generally similar molded techniques as those described above with respect to FIGS. 8 through 10. However, the single generally rectangular base 180 may be attached to multiple molded sections 178. The small sharp tines of the molded sections 178 may be used to overcome the resistance of the stratum corneum of the skin of a patient when the EEG sensor 170 is attached to the patient. As such, EEG sensors 170 using the sharp molded features presented herein may be electrically coupled to the patient more effectively, such that the signal quality detected by the associated electrodes 172 is more reliable.

However, EEG sensors are only one of numerous applications for the molded pieces 152, 176 illustrated in FIGS. 10, 11, 12A, and 12B. Indeed, the mold techniques described herein may be extended to any applications (e.g., various medical device applications, such as electrocardiogram (ECG/EKG) sensors, and so forth) where the creation of sharp features in molded pieces would prove beneficial. It should be noted that the mold techniques described herein may be used to created mold pieces that are very small. For example, the molded piece 152 of FIGS. 10 and 11 may have a rectangular base 154 with edges 158 on the order of 0.018 inches, and a height on the order of 0.02 inches. As such, the mold techniques described herein enable the creation of molded pieces 152 with sharp features, while still enabling relatively small overall dimensions (e.g., in certain embodiments, smaller than 0.2 inches, 0.1 inches, 0.05 inches, 0.02 inches, or even smaller).

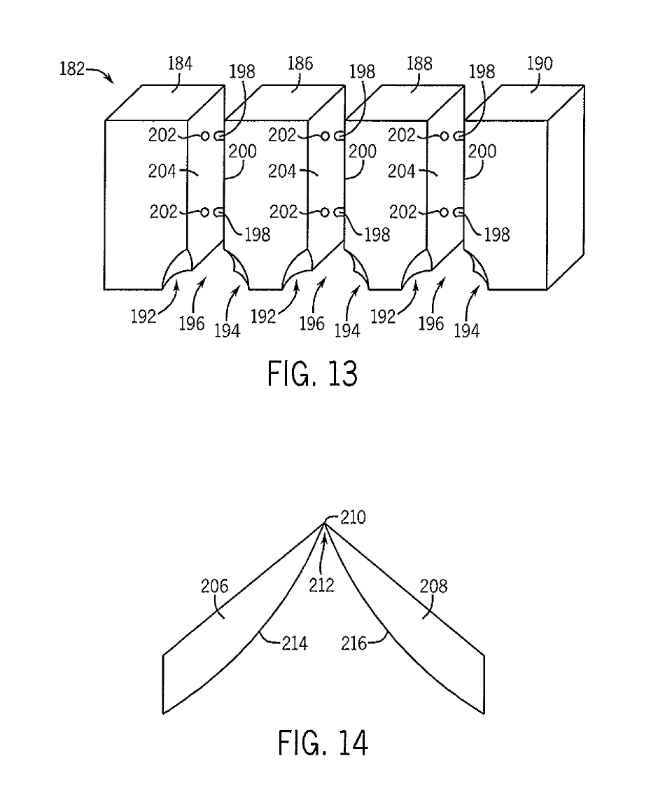

The mold plates described above have been single pieces that mate with abutting mold plates to form a combined mold cavity. However, in other embodiments, each mold plate may include multiple mold plate pieces that combine to form the mold plate. For example, FIG. 13 is a perspective view of a mold plate 182 having multiple mold plate pieces 184, 186, 188, 190 in accordance with an embodiment. In particular, the mold plate 182 of FIG. 13 is substantially similar to the mold plate 68 of the mold assembly 66 of FIG. 5. However, the multiple mold plate pieces 184, 186, 188, 190 of the multi-piece mold plate 182 enables the creation of sharp edges between mold cavity segments 192, 194 (e.g., halves, or some smaller fraction) of the mold plate pieces 184, 186, 188, 190 that form the mold cavities 196 of the mold plate 182. In other words, the multi-piece mold plate 182 enables the formation of sharp edges both between abutting mold plate pieces 184, 186, 188, 190, and between the mold plate 182 and an abutting mold plate (e.g., the second mold plate 70 of FIG. 5, and so forth).

In certain embodiments, the multiple mold plate pieces 184, 186, 188, 190 include features for aligning and/or securing the mold plate pieces 184, 186, 188, 190 with each other. For example, as illustrated in FIG. 13, in certain embodiments, the mold plate pieces 184, 186, 188, 190 may include alignment pins 198 that extend from one side 200 of the mold plate pieces 184, 186, 188, 190 and mating alignment holes 202 that are machined into an opposite side 204 of the mold plate pieces 184, 186, 188, 190. The use of multiple mold plate pieces 184, 186, 188, 190 in a single mold plate 182 increases the modularity and reusability of the mold plate 182. For example, multiple mold plate pieces 184, 186, 188, 190 may enable the assembly of various configurations and alignments of mold plate pieces 184, 186, 188, 190 to form a given mold plate 182.

As described above, the devices and techniques presented herein enable the creation of sharp features between abutting mold plates (and, indeed, between abutting mold plate pieces of multi-piece mold plates). In addition, the sharp features described herein may be extremely acute and, indeed, may lead to “knife edges,” depending on the configuration and alignment of the abutting mold plates. For example, FIG. 14 is a side view of first and second mold plates 206, 208 that meet at a point 210 and include an acute sharp feature 212 between abutting sides 214, 216 of the respective mold plates 206, 208 in accordance with an embodiment. As such, FIG. 14 illustrates the degree of sharp features capable using the devices and techniques presented herein.

As described above, three or more mold plates may be provided to create a single mold assembly. In addition, in certain embodiments, one or more of the mold plates may include one or more mold plate pieces, such that the mold plate pieces may be assembled into a single mold plate (sometimes in varying configurations). Each mold plate includes one or more mold cavities, each having one or more surfaces. The provided mold plates may be assembled to form the mold assembly having a combined mold cavity between adjacent mold cavities of the mold plates. Although none of the individual mold cavities of the mold plates include sharp features, when the mold assembly is assembled, a combined mold cavity will include sharp transitions (e.g., angles of less than 180 degrees, right angles, angles of less than 90 degrees, and so forth) between adjacent surfaces of the mold cavities. In certain embodiments, sets of mold plates may be re-aligned to create varying mold cavity geometries. In addition, in certain embodiments, a mold pin may be inserted into an inner volume of a mold plate to both create additional sharp transitions between adjacent surfaces.

In addition, as described above, the two or more of the mold plates presented herein are assembled together and remain assembled together during multiple cycles of molding operation. For example, once a mold assembly is assembled together, a first cycle of a molding operation may be performed, during which a thermoplastic material is injected into the mold assembly to form a first molded product having sharp features. Next, the first molded product may be removed from the mold assembly without disassembling two or more of the mold plates from the mold assembly. Then, a second cycle of the molding operation may be performed, during which the thermoplastic material is injected into the mold assembly to form a second molded product having sharp features. In this manner, the assembled mold plates facilitate the creation of the sharp features in multiple mold products formed during multiple cycles of the molding operation.

While the disclosure may be susceptible to various modifications and alternative forms, specific embodiments have been shown by way of example in the drawings and have been described in detail herein. However, it should be understood that the embodiments provided herein are not intended to be limited to the particular forms disclosed. Indeed, the disclosed embodiments may be applied to various types of medical devices and monitors, as well as to electronic devices in general. Rather, the various embodiments may cover all modifications, equivalents, and alternatives falling within the spirit and scope of the disclosure as defined by the following appended claims.

What is claimed is:

1. A mold assembly, comprising:
a first mold plate having a first mold cavity with a first surface;
a second mold plate having a second mold cavity with a second surface, wherein the first and second mold cavities are disposed adjacent each other to form a combined mold cavity when the first and second mold plates are aligned with each other, wherein a sharp transition is formed between the first and second surfaces when the first and second mold plates are aligned with each other, and wherein the first and second mold plates are configured to remain aligned with each other during multiple cycles of a molding operation; and
a third mold plate disposed adjacent to the first and second mold plates to close the combined mold cavity.

2. The mold assembly of claim 1, wherein the sharp transition comprises an angle of less than 180 degrees where the first and second surfaces abut.

3. The mold assembly of claim 1, wherein the sharp transition comprises an angle of less than 90 degrees where the first and second surfaces abut.

4. The mold assembly of claim 1, wherein the first and second mold plates are configured to align with each other in a plurality of configurations to modify a shape of the combined mold cavity.

5. The mold assembly of claim 1, wherein the first and second mold cavities include only linear or curvilinear surfaces and linear or curvilinear transitions between adjacent surfaces.

6. The mold assembly of claim 1, wherein the first mold plate comprises first and second mold plate pieces having first and second respective mold cavity segments that form the first mold cavity when the first and second mold plate pieces are aligned with each other.

7. The mold assembly of claim 1, comprising a mold pin, wherein the first mold plate comprises an inner volume, and wherein the mold pin is configured to fit within the inner volume and to extend at least partially into the first mold cavity.

8. The mold assembly of claim 7, wherein the mold pin is a cylindrical mold pin, and the inner volume is a cylindrical inner volume.

9. The mold assembly of claim 1, comprising a third mold plate having a third mold cavity with a third surface, wherein the first, second, and third mold cavities are disposed adjacent each other to form the combined mold cavity when the first, second, and third mold plates are aligned with each other, and wherein the sharp transition is formed between the first, second, and third surfaces when the first, second, and third mold plates are aligned with each other.

10. A method for providing a product, comprising:
providing a first mold plate having a first mold cavity with a first surface;
providing a second mold plate having a second mold cavity with a second surface;
assembling the first and second mold plates to form a mold assembly, wherein the first and second mold cavities are disposed adjacent each other to form a combined mold cavity, and wherein a sharp mold transition is formed between the first and second surfaces;
attaching the first and second mold plates to a third mold plate to close the combined mold cavity;
injecting the mold assembly with a thermoplastic material to form a first molded product having a sharp product transition on an outer surface of the first molded product, wherein the sharp product transition is complementary to the sharp mold transition;
detaching the third mold plate from the first and second mold plates;
removing the molded product from the mold assembly without disassembling the first and second mold plates from the mold assembly; and
injecting the mold assembly with the thermoplastic material to form a second molded product having a sharp product transition on an outer surface of the second molded product, wherein the sharp product transition is complementary to the sharp mold transition.

11. The method of claim 10, wherein assembling the first and second mold plates comprises forming the sharp transition as an angle of less than 180 degrees where the first and second surfaces abut.

12. The method of claim 10, wherein assembling the first and second mold plates comprises forming the sharp transition as an angle of less than 90 degrees where the first and second surfaces abut.

13. The method of claim 10, comprising re-aligning the first and second mold plates with respect to each other to modify a shape of the combined mold cavity.

14. The method of claim 10, comprising providing the first and second mold plates having first and second mold cavities with only linear or curvilinear surfaces and linear or curvilinear transitions between adjacent surfaces.

15. The method of claim 10, wherein providing the first mold plate comprising first and second mold plate pieces having first and second respective mold cavity segments that form the first mold cavity when the first and second mold plate pieces are aligned with each other.

16. The method of claim 10, comprising inserting a cylindrical mold pin into a cylindrical inner volume of the first mold plate and at least partially through the first mold cavity.

17. The method of claim 10, comprising providing a third mold plate having a third mold cavity with a third surface, and assembling the first, second, and third mold plates to form the combined mold assembly, wherein the first, second, and third mold cavities are disposed adjacent each other to form the combined mold assembly, and wherein the sharp transition is formed between the first, second, and third surfaces.

18. A molded medical device component, comprising:
a molded body, comprising:
a rectangular base attached to one or more molded sections, each molded section comprising;
four side walls, each side wall extending from a respective side of the rectangular base, wherein each side wall is angled toward a central axis that is orthogonal to the rectangular base; and
a cylindrical inner volume, wherein an inner wall of the cylindrical inner volume is concentric to the central axis.

19. The molded medical device component of claim 18, wherein each side wall comprises a parabolic side opposite the respective side of the rectangular base.

20. The molded medical device component of claim 18, wherein the molded body is a one-piece molded body.
